(19) United States
(12) Patent Application Publication
(10) Pub. No.: US 2016/0231223 A1
(43) Pub. Date: Aug. 11, 2016

(54) FLUIDIC CHIP FOR FLOW CYTOMETRY AND METHODS OF USE

(71) Applicants: CapitalBio Corporation, Beijing (CN); Tsinghua University, Beijing (CN)

(72) Inventors: Dong WANG, Beijing (CN); Zhen CHENG, Beijing (CN); Danyang MEI, Beijing (CN); Dongliang AN, Beijing (CN); Wei YANG, Beijing (CN); Xiaokun QIN, Beijing (CN)

(73) Assignees: CapitalBio Corporation, Beijing (CN); Tsinghua University, Beijing (CN)

(21) Appl. No.: 15/019,715

(22) Filed: Feb. 9, 2016

(30) Foreign Application Priority Data
Feb. 10, 2015 (CN) 201510070063.9

(51) Int. Cl. G01N 15/14; B01L 3/00

(52) U.S. Cl. CPC G01N 15/1404; B01L 3/502715; B01L 2200/027; B01L 2300/0654; B01L 2300/0887; B01L 2300/041; B01L 2200/0652; B01L 2300/12; G01N 2015/142; G01N 2015/149; G01N 2015/1006

(57) ABSTRACT

The present disclosure in some embodiments provides a flow cell sorting system, a focus detection method, as well as a fluidic chip. In one aspect, the fluidic chip comprises a cover sheet and one or more substrate layers, and one or more channels in each of the fluidic chips. In one aspect, the cells or other analytes in a sample are focused onto the same plane as they flow through the fluidic channel. In another aspect, the cells or other analytes on the same plane are irradiated with the same light intensity, for example, by a flat-top laser beam. This combination eliminates or reduces variation caused by cells at different positions receiving different intensities of the excitation light, and therefore improves accuracy of the flow cytometry analysis. In another aspect, a sorting apparatus is designed at the junction of the detection area and the outlet channel to separate the target cells.

### CROSS-REFERENCE TO RELATED APPLICATIONS

This application claims priority to Chinese Patent Application No. 201510070063.9, filed on Feb. 10, 2015, the content of which is incorporated by reference herein in its entirety for all purposes.

### TECHNICAL FIELD

The present application relates to the field of cell detection and analysis, and more particularly, relates to a flow cytometry system, a hydrodynamic focusing technique, a method of detection based on fluidic focusing, and a fluidic chip.

### BACKGROUND

Flow cytometry (or FCM, for short) was invented on the basis of the development of multi-disciplinary combination and comprehensive progress of microscopy, chemical staining, electronics, and computer technology. FCM can rapidly analyze the characteristics and composition of a sequential flow of single cells (e.g., single cells in rapid linear flow) or other various small particles (such as bacteria) thereof, and separate a subpopulation of the cells or particles. Not only can FCM be used to measure cell size and the shape of internal particle or structure, but also can FCM recognize the antigens on the cell surface and in the cytoplasm, and intracellular DNA and RNA content, etc., in order to perform single cell level analysis in different subpopulations of cells. FCM can detect and analyze a large number of cells in a short time, in order to acquire multi-parameter and quantitative information. The data could be collected, stored and processed, while a sub-population of cells can be separated and recovered. FCM has been widely used in hematology, immunology, oncology, pharmacology, genetics, clinical testing, molecular biology, cell dynamics and environmental microbiology and other disciplines.

Flow cytometry techniques include analyzing systems and sorting systems (or flow cytometer). The latest commercial flow cytometer mainly contains an optical system, an electronic detection system, and fluidic chips. The cell samples are constrained into a single-cell flow through hydrodynamic focusing, irradiated by an external laser in the fluidic chip, and then the electronic processing system acquires the scatter light signal and the excitation light signals in order to finally analyze the parallel data from the samples and to separate target cells.

Nowadays, in some sheath-free or capillary fluidic flow cytometry, the cells to be tested from the sample are randomly distributed within the fluidic channel. Since cells can be injected with different velocity at different locations of the channel according to the effect of Poiseuille flow, the pulse width and coefficient of variation (CV) of the same cell detected at different locations in the channel can be non-uniform, resulting in a poor accuracy of the testing results. There is need for flow cytometry devices and methods with improved assay accuracy.

### SUMMARY

The summary is not intended to be used to limit the scope of the claimed subject matter. Other features, details, utilities, and advantages of the claimed subject matter will be apparent from the detailed description including those aspects disclosed in the accompanying drawings and in the appended claims.

To solve problems associated with conventional flow cytometry, provided herein in some embodiments is a fluidic chip and a flow cytometry cell sorting system comprising the fluidic chip, using cell focusing and a shaped laser, with improved accuracy of the analysis.

In some embodiments, a flow cell sorting system, a focusing detection method, and a fluidic chip are disclosed herein. In one aspect, the fluidic chip comprises a cover layer and a substrate layer; a channel in the fluidic chip comprising an inlet port, one or more outlet ports, a detection zone between the inlet and the outlet. In some aspects, the chip further comprises a sorting structure or apparatus designed at the junction of a detection area and an outlet channel. In one aspect, an ultrasonic driving area is provided by providing a lead zirconate titanate (PZT) slice attached to the lower surface of the substrate layer. In another aspect, ultrasound energy is provided upstream of the detection zone for ultrasonic focusing of cells into a single-cell flow. In one aspect, a light detection region is provided crossing the lower surface of the substrate layer, wherein the detection region is illuminated by a shaped flat-top laser spot provided by a laser device. In one other aspect, the sample in the detection zone is irradiated with the flat-top laser beam provided by the laser device. In another aspect, the fluidic chip further comprises an outlet of sorted samples (for example, samples of interest such as a cell or a cell population that meets predetermined criteria for sorting, e.g., CD4⁺ cells) and an outlet of other samples (for example, unsorted samples, or samples not of interest such as a cell or a cell population that does not meet predetermined criteria for sorting, e.g., CD4⁻ cells). In one aspect, the sorting structure or apparatus is used to sort the wanted cells in a sample into a collection tube or well.

In one aspect, disclosed herein is a fluidic chip for analyzing a sample, comprising: a fluidic channel comprising an inlet for adding a sample, and an outlet; a driving region and an optical detection region which are arranged sequentially in the direction of sample flow from the inlet to the outlet, wherein: the driving region is an ultrasound driving region configured to provide an ultrasound to focus analytes in the sample onto substantially the same plane as the analytes flow through the fluidic channel in the ultrasound driving region, and the optical detection region is configured to provide a light to irradiate the analytes as they flow through the fluidic channel in the optical detection region after being focused onto substantially the same plane, such that the analytes on the same plane receive substantially the same intensity of light irradiation; or the driving region is configured to provide a force to focus analytes in the sample onto substantially the same plane as the analytes flow through the fluidic channel in the driving region, and the optical detection region is configured to provide a flat-top light beam to irradiate the analytes as they flow through the fluidic channel in the optical detection region after being focused onto substantially the same plane, such that the analytes on the same plane receive substantially the same intensity of light irradiation; or the driving region is an ultrasound driving region configured to provide an ultrasound to focus analytes in the sample onto substantially the same plane as the analytes flow through the fluidic channel in the ultrasound driving region, and the optical detection region is configured to provide a flat-top light beam to irradiate the analytes as they flow through the fluidic channel in the optical detection region after being focused onto substantially the same plane, such that the analytes on the same plane receive substantially the same intensity of light irradiation.

In one aspect, provided herein is a fluidic chip for a flow cell sorting system, which comprises an upper cover and a substrate layer, which can be positioned opposite to each other and bonded and sealed to form a closed fluidic chip (except at an inlet or an outlet); a fluidic channel inside such fluidic chip, which comprises one or more inlets at a first end of the fluidic chip, and one or more outlets at a second end of the fluidic chip, and a detection area between the inlet(s) and the outlet(s); a sorting system at the junction of such detection area and the outlet(s); an ultrasonic driving area provided in the substrate layer, for example, on the lower surface of the substrate layer, for ultrasonic focusing of cells or particles in the sample in the detection zone within the fluid conduit or channel; a light detection region provided in the substrate layer, for example, on the lower surface of the lower chip, for setting a laser device for shaping a laser, which in some aspects is a flat-top laser spot for irradiating the cells or particles in a sample in the detection zone. In some embodiments, the device further comprises an outlet of sorted samples and an outlet of other samples, including unsorted samples or unselected samples. In some aspects, when the chip is used to detect and/or analyze a sample, a sorting system is used to select the desired cells or other analytes in the sample flowing through the fluidic channel.

In one embodiment, the cover sheet or layer and the lower chip or substrate layer are separable. In one aspect, the fluid channel comprises a groove provided on the surface of the lower chip or substrate layer facing the cover sheet.

In one aspect, the cover layer of the fluidic chip comprises: a sample inlet connected to the inlet(s) of the lower chip or substrate layer; a first cover-layer outlet connected to the outlet of sorted samples of the lower chip or substrate layer; and a second cover-layer outlet connected to the outlet of unsorted samples of the lower chip or substrate layer. In one aspect, the cover sheet of the fluidic chip further comprises a rinsing outlet connected to the fluidic channel, for example, for rinsing the sorted samples. In another aspect, the sorting system of the fluidic chip comprises a sorting groove provided on the surface of the lower chip facing the cover sheet.

In another aspect, the cover layer of the fluidic chip further comprises: one or more electrode through-holes provided in the cover layer at position(s) corresponding to the sorting groove in the substrate layer when the cover layer and the substrate layer are bonded and sealed, such that one or more electrodes can be inserted into the sorting groove through the hole(s) on the cover layer.

In another aspect, the fluidic chip further comprises a fluidic channel comparing a sorted sample channel provided between the detection zone and the sorted sample outlet. In yet another aspect, the fluidic chip further comprises a fluidic channel comparing an unsorted sample channel provided between the detection zone and the unsorted sample outlet.

In one aspect, the width of the unsorted sample channel is greater than the width of the sorted sample channel, and the channels have the same extending direction.

In another aspect, the upper cover sheet and/or the lower chip are made of or comprise glass and/or plastic. In one aspect, the material of the cover sheet and the lower chips are glass, and the ratio of the thickness of the lower chip located below the fluid channel, the height of the fluid channel, and the thickness of cover sheet located above the fluid channel is about 2:1:2. Some variations are allowed, as long as standing waves can be formed inside the fluidic channel to effectively focus analytes in the sample substantially onto the same plane. In particular embodiments, the analytes are substantially focused onto the same plane when 100% or at least about 99%, 95%, 90%, 85%, or 80% of the analytes in a portion of the fluidic channel are focused on the same horizontal plane extending in the direction of sample flow.

In one aspect, the cross-section of the fluidic channel of the fluidic chip in the extending direction of the fluidic chip is rectangular or square.

Also provided herein is a flow cytometry sorting system, comprising: a fluidic chip according to any of the preceding embodiments; an ultrasound device provided in the ultrasonic driving zone that is used to focus the cells or particles in the sample in the fluidic channel through focused ultrasound; a laser device in the light detection zone, which is used to detect and/or analyze cells or particles in the sample in the detection zone by a flat-top spot light, as the cells in the sample flow through the microfluidic channel of the fluidic chip; an electronic testing system for data collection and/or analysis.

In another aspect, provided herein is a detection and/or analytical method using a focusing technology (such as an ultrasound cell focusing technology) and a flow cytometry sorting system, which method comprises: injecting a sample into the fluidic chip as disclosed in any of the preceding embodiments; focusing the sample with an ultrasonic force; irradiating the sample with a flat-top laser spot; collecting and/or sorting target cells after the sample analysis.

In one aspect, the fluid chip provided herein comprises: a cover sheet and a lower chip, which are opposite to each other; a fluid channel inside such fluidic chip, which comprises an inlet at a first end of the fluidic chip, one or more outlets at a second end of the fluidic chip, and a detection area between the inlet and the outlet; a detection region located between the inlet and the outlet(s); a sorting system at the junction of such detection area and the outlet; an ultrasonic driving area provided on the lower surface of the lower chip; an ultrasound device provided in the driving zone for ultrasonic focusing samples within the fluid channel; a light detection region provided through the lower surface of the lower chip; a light source such as a laser device set below the light detection region of the fluidic channel for providing shaped laser, wherein the sample in the detection zone is irradiated with a flat-top spot emitted by the light source; an outlet of sorted samples and an outlet of other samples; and a sorting system for sorting the samples in the fluidic channel.

In one aspect, the detection zone (including the ultrasound driving zone and the light detection zone) in the fluidic channel of the fluidic chip can be used for ultrasound focusing of the sample and for flat-top beam irradiation of the sample.

Using ultrasound to focus the cells in a sample inside the channel can drive the cells onto a set horizontal plane as they flow through the fluidic channel. At the same time, in one aspect, the cells moving on the same horizontal plane are irradiated by a flat-top beam to ensure that the cells at different positions on the horizontal plane receive substantially the same light intensity. This way, the combination of the cell focusing technology and flat-top beam irradiation improves the accuracy of the flow cytometry analysis.

In one aspect, provided herein is a fluidic chip for analyzing a sample, comprising a fluidic channel which comprises an inlet for adding a sample, and one or more outlets (such as two or more outlets), and an ultrasound driving region and an optical detection region which are arranged sequentially in the direction of sample flow from the inlet to the outlet. In some embodiments, an ultrasound is provided in the ultrasound driving region to focus analytes in the sample onto substantially the same plane as the analytes flow through the fluidic channel in the ultrasound driving region. In other embodiments, a flat-top light beam is provided in the optical detection region to irradiate analytes as they flow through the fluidic channel in the optical detection region after being focused onto substantially the same plane, such that analytes on the same plane receive substantially the same irradiation intensity of flat-top light.

In any of the preceding embodiments, the fluidic chip can comprise a cover layer and a substrate layer which are capable of engaging each other.

In any of the preceding embodiments, the cover layer and the substrate layer can be bonded and sealed to provide the fluidic channel.

In any of the preceding embodiments, the fluidic channel can comprise one inlet and at least two outlets. In one aspect, the one inlet is provide at a first end of the fluidic channel and the at least two outlets are provided at a second end of the fluidic channel. In another aspect, the at least two outlets comprise an outlet for analytes of interest and another outlet for analytes not of interest.

In any of the preceding embodiments, the fluidic chip can further comprise a sorting structure or apparatus between the optical detection region and the outlet(s).

In any of the preceding embodiments, the ultrasound driving region can comprise an ultrasound device for providing the ultrasound, for example, the ultrasound device can provided externally to the fluidic channel but still integrated with the fluidic chip (e.g., by attaching the ultrasound device to the lower surface of the substrate layer and positioning it below the fluidic channel in the ultrasound driving region.

In any of the preceding embodiments, the ultrasound device can comprise a piezoelectric ceramic. In any of the preceding embodiments, the ultrasound driving region can comprise a lead zirconate titanate (PZT) slice attached to the lower surface of the substrate layer and positioned below the fluidic channel in the ultrasound driving region.

In any of the preceding embodiments, the optical detection region can comprise a light source for providing the flat-top light beam.

In any of the preceding embodiments, the cover layer can comprise a sample inlet capable of being in fluidic communication with the inlet of the fluidic channel when the cover layer and the substrate layer are engaged. In one aspect, the cover layer can further comprise a first cover-layer outlet capable of being in fluidic communication with the outlet for analytes of interest when the cover layer and the substrate layer are engaged. In one aspect, the cover layer can further comprise a second cover-layer outlet capable of being in fluidic communication with the outlet for analytes not of interest when the cover layer and the substrate layer are engaged.

In any of the preceding embodiments, the cover layer can further comprise a rinsing outlet capable of being in fluidic communication with the fluidic channel.

In any of the preceding embodiments, the fluidic chip can further comprise a sorting structure or apparatus between the optical detection region and the outlet, the sorting structure or apparatus can comprise a sorting groove provided on the substrate layer, and the cover layer can further comprise a through-hole for inserting one or more electrodes in the sorting groove.

In any of the preceding embodiments, the sorting structure or apparatus can generate bubbles of hydrogen and/or oxygen to direct analytes of interest through the fluidic channel and toward the outlet for analytes of interest.

In any of the preceding embodiments, the fluidic chip can further comprise a first segment of the fluidic channel for analytes of interest between the optical detection region and the outlet for analytes of interest, and a second segment of the fluidic channel for analytes not of interest between the optical detection region and the outlet for analytes not of interest. In one aspect, the average diameter of the fluidic channel for analytes not of interest is greater than the average diameter of the fluidic channel for analytes of interest.

In any of the preceding embodiments, the fluidic chip can further comprise a sorting structure or apparatus between the optical detection region and the first and second segments of the fluidic channel.

In any of the preceding embodiments, the cover layer and/or the substrate layer can comprise glass and/or plastic.

In any of the preceding embodiments, both of the cover layer and the substrate layer can be made of glass, and when the cover layer and the substrate layer are bonded and sealed, the ratio of the glass thickness below the fluidic channel, the height of the fluidic channel, and the glass thickness above the fluidic channel can be about 2:1:2.

In any of the preceding embodiments, the cross-section of the fluidic channel in the direction of sample flow can be square or rectangular in shape.

Also provided herein is a flow cytometry system, comprising the fluidic chip of any of the preceding embodiments, an ultrasound device for providing the ultrasound, a light source for providing the flat-top light beam, and an electronic system for data collection and analysis.

In another aspect, provided herein is a method for analyzing a sample, comprising: loading a sample in the inlet of the fluidic chip of any of the preceding embodiments; focusing analytes in the sample onto substantially the same plane as the analytes flow through the fluidic channel; irradiating analytes as they flow through the fluidic channel with a flat-top light beam after the analytes are focused onto substantially the same plane, such that analytes on the same plane receive substantially the same flat-top light irradiation; and collecting scatter light and/or fluorescent light signals from the analytes and comparing the light signals with a predetermined value; and sorting the analytes into analytes of interest and analytes not of interest based on the comparison, for example, sorting the analytes into outlet(s) for analytes of interest and outlet(s) for analytes not of interest based on the comparison.

In another aspect, disclosed herein is a method for analyzing a sample, comprising: loading a sample in the inlet of the fluidic chip of any of the preceding embodiments; focusing analytes in the sample onto substantially the same plane as the analytes flow through the fluidic channel, optionally using an ultrasound; irradiating analytes as they flow through the fluidic channel with a light beam, optionally a flat-top light beam, after the analytes are focused onto substantially the same plane, such that analytes on the same plane receive substantially the same intensity of light irradiation; and collecting scatter light and/or fluorescent light signals from the analytes and comparing the light signals with a predetermined value; and sorting the analytes into analytes of interest and analytes not of interest based on the comparison.

In any of the preceding embodiments, the analytes can comprise a cell, an organelle, a cell fragment, a multicellular organism, and/or a multicellular complex.

### BRIEF DESCRIPTION OF THE DRAWINGS

FIG. 1A is a structural diagram showing the structure of a bio-chip according to one aspect the present disclosure.

FIG. 1B is a partial enlarged view of FIG. 1A.

FIG. 2 is a schematic diagram of the principle of flat-top laser spot irradiation according to one aspect of the present disclosure.

FIG. 3 is a sectional view of the fluidic chip shown in FIG. 1A and FIG. 1B.

FIG. 4 is an elevated view of the fluidic chip shown in FIG. 1A and FIG. 1B.

FIG. 5 is a structural diagram showing the structure of a flow cytometry sorting system according to one aspect the present disclosure.

FIG. 6 is a schematic diagram of the results of ultrasonic focusing of cells or particles.

FIG. 7 is a schematic flow of a focusing detection method using a flow cytometry cell sorting system according to one aspect the present disclosure.

### DETAILED DESCRIPTION

A detailed description of one or more embodiments of the claimed subject matter is provided below along with accompanying figures that illustrate the principles of the claimed subject matter. The claimed subject matter is described in connection with such embodiments, but is not limited to any particular embodiment. It is to be understood that the claimed subject matter may be embodied in various forms, and encompasses numerous alternatives, modifications and equivalents. Therefore, specific details disclosed herein are not to be interpreted as limiting, but rather as a basis for the claims and as a representative basis for teaching one skilled in the art to employ the claimed subject matter in virtually any appropriately detailed system, structure, or manner. Numerous specific details are set forth in the following description in order to provide a thorough understanding of the present disclosure. These details are provided for the purpose of example and the claimed subject matter may be practiced according to the claims without some or all of these specific details. It is to be understood that other embodiments can be used and structural changes can be made without departing from the scope of the claimed subject matter. It should be understood that the various features and functionality described in one or more of the individual embodiments are not limited in their applicability to the particular embodiment with which they are described. They instead can, be applied, alone or in some combination, to one or more of the other embodiments of the disclosure, whether or not such embodiments are described, and whether or not such features are presented as being a part of a described embodiment. For the purpose of clarity, technical material that is known in the technical fields related to the claimed subject matter has not been described in detail so that the claimed subject matter is not unnecessarily obscured.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

All publications referred to in this application are incorporated by reference in their entireties for all purposes to the same extent as if each individual publication were individually incorporated by reference.

All headings are for the convenience of the reader and should not be used to limit the meaning of the text that follows the heading, unless so specified.

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6.

As used herein and in the appended claims, the singular forms “a,” “an,” and “the” include plural referents unless the context clearly dictates otherwise. For example, “a” or “an” means “at least one” or “one or more.” Thus, reference to “a through-hole” refers to one or more through-holes, and reference to “the method” includes reference to equivalent steps and methods disclosed herein and/or known to those skilled in the art, and so forth.

It is understood that aspects and embodiments of the disclosure described herein include “consisting” and/or “consisting essentially of” aspects and embodiments.

A “chip” used herein can include a microchip, which comprises a solid substrate with a plurality of one-, two- or three-dimensional micro structures or micro-scale structures on which certain processes, such as physical, chemical, biological, biophysical or biochemical processes, etc., can be carried out. The micro structures or micro-scale structures such as, channels and wells, are incorporated into, fabricated on or otherwise attached to the substrate for facilitating physical, biophysical, biological, biochemical, chemical reactions or processes on the chip. The chip may be thin in one dimension and may have various shapes in other dimensions, for example, a rectangle, a circle, an ellipse, or other irregular shapes. The size of the major surface of chips can vary considerably, e.g., from about 1 mm² to about 0.25 m². Preferably, the size of the chips is from about 4 mm² to about 25 cm² with a characteristic dimension from about 1 mm to about 5 cm. The chip surfaces may be flat, or not flat. The chips with non-flat surfaces may include channels or wells fabricated on the surfaces.

A “sample” used herein can include a biological sample, which may include any sample obtained from a living or viral (or prion) source or other source of macromolecules and biomolecules, and include any cell type or tissue of a subject from which nucleic acid, protein and/or other macromolecule can be obtained. The biological sample can be a sample obtained directly from a biological source or a sample that is processed. For example, isolated primary cells that are cultured and/or manipulated in vitro constitute a biological sample. Biological samples include, but are not limited to, body fluids, such as blood, plasma, serum, cerebrospinal fluid, synovial fluid, urine and sweat, tissue and organ samples from animals and plants and processed samples derived therefrom.

An “analyte” used herein can include a cell (including a single cell organism); a subcellular analyte such as organelles, e.g., mitochondria, Golgi apparatus, endoplasmic reticulum, chloroplasts, endocytic vesicles, exocytic vesicles, vacuoles, lysosomes, etc.; a multicellular organism; or a multicellular complex. An “analyte” can include any biological molecules including but not limited to proteins, nucleic acids, lipids, carbohydrates, ions, or multicomponent complexes containing any of the above.

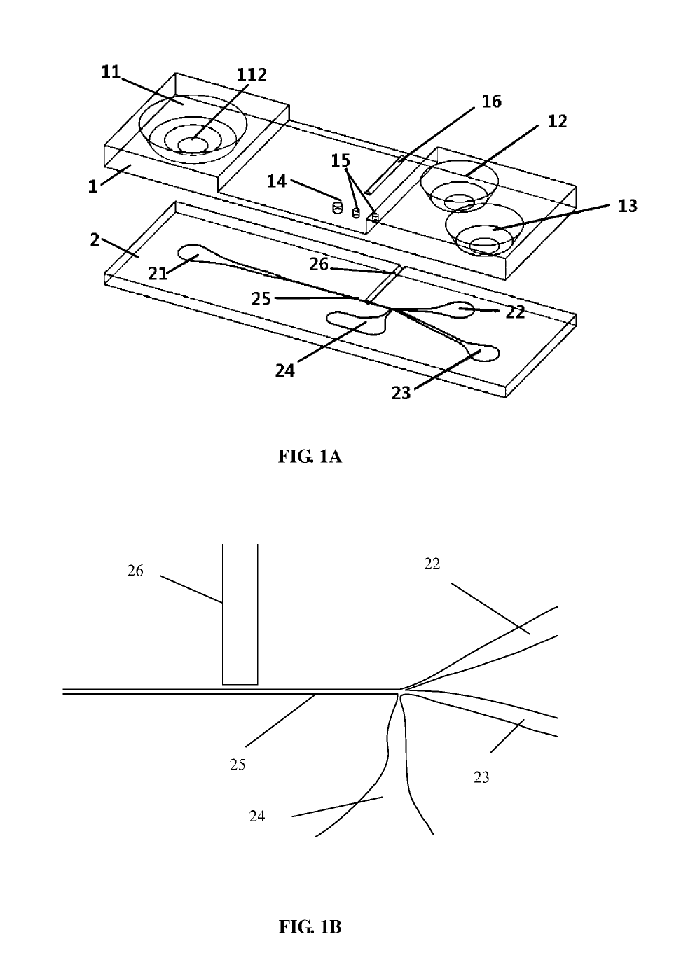

In one aspect, provided herein is a fluidic chip for a flow cytometer cell sorting system, for example, as shown in FIG. 1A and FIG. 1B. FIG. 1A is a structural diagram showing the structure of a microfluidic chip (such as a biochip) according to one aspect of the present disclosure. FIG. 1B is a partially enlarged view of FIG. 1A, and the fluidic chip comprises an upper cover layer 1 and a substrate layer 2, which are opposite to each other. In one embodiment, the cover layer and the substrate layer fittingly engage each other.

In one aspect, the cover layer and the substrate layer of the fluidic chip are separately designed and/or manufactured, and can be separated from each other, for example, for packaging and shipping, or after use for cleaning and subsequent reuse. In one aspect, one or more fluidic channels or a fluidic channel network are provided in the fluidic chip (such as a microfluidic chip), comprising: an inlet 21 provided at a first end of the fluidic chip; one or more outlets provided at a second end of the fluidic chip; a main fluidic channel 25 located between the inlet and the outlet(s). In some embodiments, the outlets comprise an outlet for sorted samples (e.g., outlet 22) and an outlet for unsorted samples (e.g., outlet 23). In some embodiments, the outlets comprise an outlet for cells (or other analytes) selected for according to predetermined parameter(s) and an outlet for cells (or other analytes) that do not meet the selection parameter(s).

In one aspect, a sorting structure or apparatus is disposed at the junction of the detection region and the outlets. When a cell is detected in the fluidic chip and determined to fit the user-defined threshold values, the sorting system is triggered to direct the target cell into a fluidic channel for sorted samples connected to the outlet for sorted samples.

In one aspect, the fluidic chip comprises an ultrasonic driving zone, which is provided below substrate layer 2 such as on the lower surface of the substrate layer 2, and upstream of a light detection region (for example, light detection region 36). In one aspect, the light detection region is provided through the lower surface of the substrate layer 2. In one aspect, an ultrasound actuator is provided in the ultrasound driving zone, in order to focus cell samples into the middle of the fluidic channel by ultrasonic force. In one aspect, the light detection region is illuminated by a laser device, for example, a laser device that is capable of emitting a flat-top beam of laser. In one aspect, when cells in a sample pass through the channel and across the detection zone, the cells are irradiated by the flat-top laser beam. A flat-top beam (or top-hat beam) is a light beam (often a transformed laser beam) having an intensity profile which is flat over most of the covered area. This is in contrast to Gaussian beams, for example, where the intensity smoothly decays from its maximum on the beam axis to zero.

In specific embodiments, the ultrasound device is a transducer disposed below the main fluidic channel 25. In one aspect, the ultrasound device which may generate ultrasound waves is provided in the ultrasonic driving zone and upstream of the light detection zone 36. In one aspect, the ultrasound device such as a transducer is adhered to the lower surface of the substrate layer 2 using a glue or gel, for example, an ultrasonic coupling glue. In one aspect, the ultrasonic coupling glue can fix the transducer and the fluidic chip together. In another aspect, the sound is transmitted to the fluidic channel with maximum efficiency through the coupling glue which reduces the acoustic attenuation in the transmission process.

In one aspect, a sound wave emitted by the ultrasound device penetrates the part of the substrate layer 2 which is below the fluidic channel 25, and the part of the fluidic channel that corresponds to driving region. The sound wave is then reflected back by cover layer 1, due to the high reflection coefficient of the air. These reflected waves and the incident sound waves form standing waves (e.g., waves 41) in the fluidic channel corresponding to the ultrasonic driving zone, constraining the cell into the ultrasonic pressure node which in some aspects is in the middle of the channel.

In one aspect, the ultrasound device is provided below the substrate layer 2, for example, on the lower surface of the substrate lawyer. The area of where the ultrasound device is fixed (e.g., the ultrasonic driving zone) and the incident illumination area of the laser device (e.g., light detection region 36) are directly vertically below the main fluidic channel, and arranged along the flow direction of the sample. In one aspect, the area of where the ultrasound device is fixed is upstream relative to the illumination area of the laser device.

In one aspect, the fluidic channel comprises one or more grooves on the surface of the substrate layer 2 facing the cover layer 1. Before the assay, cover layer 1 and substrate layer 2 can be bonded and sealed, the groove is lidded by the cover layer to form a closed fluidic channel except at the inlet and outlet(s).

In another aspect, the fluidic channel comprises one or more grooves on the surface of the cover layer 1 facing the substrate layer 2. Before the assay, cover layer 1 and substrate layer 2 can be bonded and sealed, the groove is lidded by the substrate layer to form a closed fluidic channel except at the inlet and outlet(s).

In yet another aspect, the fluidic channel comprises one or more grooves on the surface of the cover layer 1 facing the substrate layer 2, and one or more grooves on the surface of the cover layer 1 facing the substrate layer 2. Before the assay, cover layer 1 and substrate layer 2 can be bonded and sealed, the groove on the surface of the cover layer 1 and the groove on the surface of the substrate layer 2 to form a closed fluidic channel except at the inlet and outlet(s).

In still another aspect, the fluidic channel is provided inside the substrate layer 2 and forms a closed fluidic channel except at the inlet and outlet(s).

In some embodiments, the fluidic channel can be provided using a combination of the above-mentioned methods. For example, one part of the fluidic channel may be provided by one or more grooves on the surface of the cover layer 1, another part of the fluidic channel may be provided by one or more grooves on the surface of the substrate layer 2, and yet another part of the fluidic channel may be provided by the grooves on the surface of the cover layer 1 and the grooves on the surface of the substrate layer 2.

In one aspect, the cover layer comprises a cover layer inlet 11 capable of being connected to the inlet (e.g., inlet 21) of the fluidic channel when the cover layer and the substrate layer are bonded; a first cover-layer outlet 12 capable of being connected to the outlet of sorted sample (e.g., outlet 22); a second cover-layer outlet 13 capable of being connected to the outlet of unsorted sample (e.g., outlet 23). In one aspect, as for sample detection, the suspended cells are added and injected through the inlet 11, and the sample then flows through the inlet 21 and passes through the detection region of the main fluidic channel 25. After being sorted by the sorting system, a part of the sample (e.g., the target cells) is gathered and directed toward the first cover-layer outlet 12 through the outlet of sorted samples 22, while another part of the sample (e.g., the non-target cells) is gathered and directed to the second cover-layer outlet 13 through the outlet of unsorted samples 23. In some embodiments, the inlet 11, the first cover-layer outlet 12, and/or the second cover-layer outlet 13 comprises or comprise one or more circular groove structures. In one aspect, the grooves are gradually narrowed into three convergence ports 112 at the bottom of the inlet 11, the first cover-layer outlet 12, and the second cover-layer outlet 13, respectively. In one aspect, the diameter of convergence port 112 is less than the diameter of the circular groove of the inlet 11 (or the diameter of the first cover-layer outlet 12 or the second cover-layer outlet 13), but is the same as the diameter of inlet 21 (or outlet 22 or outlet 23) of the substrate layer. This way, when the sample is injected through the inlet 11, the sample transverses the convergence port 112 to reduce the dead volume and avoid samples gathering in the bottom of the inlet 11. In another aspect, the convergence ports 112 located at the bottom of the first cover-layer outlet 12 and the second cover-layer outlet 13 are convenient for the recovery of sorted or unsorted samples. In some embodiments, the sample volume or the sorted or unsorted sample volumes are small, and the convergence ports facilitate the application of sample and/or recovery of the sorted or unsorted samples. Thus, in one aspect, the whole sealed chip can be used to achieve cell focusing (e.g., single-cell focusing or focusing of very few cells), optical excitation, and detection of a small amount of sample or samples containing very few cells.

In one aspect, the cover layer further comprises a rinsing outlet 14 capable of being connected to the main fluidic channel when the cover layer and the substrate layer are bonded. In one aspect, before or at the beginning of sample injection, gas or bubbles trapped in the channel can be excluded via the rinsing outlet, which helps the establishment of a stable flow of the injected sample in the main fluidic channel.

In one aspect, the sorting structure or apparatus comprises a sorting groove 24 provided in the substrate layer 2, for example, on the surface facing the cover layer 1. In some aspects, the sorting structure or apparatus is provided in the cover layer or the substrate layer, or is formed between the cover layer and the substrate layer when the two are bonded and sealed.

In one aspect, one or more electrode through-holes (e.g., electrode through-holes 15) are provided in the cover layer 1 at a position corresponding to the sorting groove 24. In one aspect, the electrode through-hole(s) comprises or comprise a positive electrode through-hole and a negative electrode through-hole. In one aspect, a driving bubble for cell separation is produced when an actuating pulse is applied to the electrodes.

In one aspect, the fluidic channel comprises a channel for sorted sample, which is provided between detection region of the main fluidic channel 25 and sorted sample outlet 22. In one aspect, the fluidic channel further comprises a channel for unsorted sample, which is provided between detection region of the main fluidic channel 25 and unsorted sample outlet 23. In one aspect, the detection region is a part of the main fluidic channel 25 and comprises the ultrasonic driving zone (where the standing wave 41 is produced) and the light detection zone 36. In one aspect, the light detection zone 36 is located toward the end of the main fluidic channel (in the direction of sample flow). In one aspect, the light detection zone 36 comprises the laser irradiation region in the fluidic channel. In one aspect, the light detection zone 36 is greater than the laser irradiation region, in order to collect more scatter light and fluorescent light. In one aspect, the width of the unsorted sample channel is greater than that of the sorted sample channel, which ensures that the flow resistance inside the unsorted sample channel is less than the flow resistance inside the sorted sample channel. In one aspect, the unsorted sample channel and the main fluidic channel for light detection have the same extending direction, e.g., the channels are collinear. This way, in one aspect, the non-target cells in the middle of the main channel will automatically enter the unsorted sample channel as a default when the sorting structure or apparatus is not turned on. From the unsorted sample channel, the sample containing the non-target cells will flow through the unsorted sample outlet 23 and converge at the second cover-layer outlet 13.

In one aspect, when the cells are irradiated and recognized as target cells by the scatter light and/or fluorescent light, meaning that the scatter light and/or fluorescent properties of the cells are coincident to the user-defined values, the anode electrode arranged in the positive electrode through-hole and the cathode electrode arranged in the negative electrode through-hole will electrolyze the liquid in the sorting groove 24, and the electrolysis is used to produce hydrogen gas and oxygen gas. In one aspect, bubbles of hydrogen and/or oxygen will actuate the cells flowing across the detection zone into the sorted channel. This way, the target cells whose properties are consistent with the desired scatter light and fluorescence values are sorted into the convergent port of the first cover-layer outlet 12 after flowing through the sorted sample channel and the outlet 22 for sorted samples. In one aspect, the sample containing non-target cells are gathered into the convergent ports of the second cover-layer outlet 13 after flowing through the unsorted sample channel and the outlet of unsorted samples 23.

In one embodiment, the cover layer and/or the substrate layer can comprise glass and/or plastic. In any of the preceding embodiments, the material of the cover layer and/or the substrate layer can be or comprise plastic, glass, silicon, ceramics, or at least one kind of metal. In one example, the cover layer and/or the substrate layer can comprise a material selected from the group consisting of a silicon, a plastic, a glass, a ceramic, a rubber, a metal, a polymer, a paper and a combination thereof. In one aspect, the plastic is selected from the group consisting of polycarbonate, methyl methacrylate, polystyrene, acrylonitrile-butadiene-styrene (ABS), polyethylene and polypropylene. In one aspect, the cover layer and/or the substrate layer can be injection molded. In another aspect, the cover layer and/or the substrate layer can be fabricated by a method selected from the group consisting of gluing, dicing/cutting, slicing, anodic bonding, ultrasonic welding, and a combination thereof.

In one aspect, when the material of the cover layer and/or substrate layer is or comprises glass, the ratio of the thickness of the substrate layer located below the fluidic channel, the height of the fluidic channel, and the thickness of the cover layer located above the fluid channel is about 2:1:2 so as to facilitate the formation of standing waves 41 in fluidic channel 25 (such as in the driving zone which is upstream of detection region 36) and force the cells to the pressure node in order to achieve ultrasonic focusing. Some variations in the 2:1:2 ratio are allowed, as long as standing waves can be formed inside the fluidic channel to effectively focus analytes in the sample substantially onto the same plane. In particular embodiments, the analytes are substantially focused onto the same plane when 100% or at least about 99%, 95%, 90%, 85%, or 80% of the analytes in a portion of the fluidic channel are focused on the same horizontal plane extending in the direction of sample flow.

In one aspect, the cross-section of the fluidic channel in the extending direction of the fluidic chip is square, rectangular, circular, an ellipse, oval, or another suitable shape. In one aspect, the cross-section of the fluidic channel is rectangular—in one aspect, this makes the fluidic chip easy to be machined and convenient for the formation of single-cell flow, with a relatively low cost.

In one aspect, in the cover layer 1, inlet 11 comprises a circular groove whose diameter is about 10, 11, 12, 13, 14, 15, 16, 17, 18, 19, 20, 21, 22, 23, 24, or 25 mm and whose height is about 1, 2, 3, 4, 5, 6, 7, 8, 9, or 10 mm. In one aspect, in the cover layer 1, inlet 11 comprises a circular groove whose diameter is about 18 mm and whose height is about 4 mm.

In another aspect, the first cover-layer outlet 12 (and/or the second cover-layer outlet 13) comprises a circular groove whose diameter is about 1, 2, 3, 4, 5, 6, 7, 8, 9, 10, 11, 12, 13, 14, 15, 16, 17, 18, 19, 20, 21, 22, 23, 24, or 25 mm and the diameter of the convergent port is about 1, 2, 3, 4, 5, 6, 7, 8, 9, or 10 mm. In another aspect, the first cover-layer outlet 12 comprises a circular groove whose diameter is about 14 mm and the diameter of the convergent port is about 5 mm. In one aspect, the second cover-layer outlet 13 comprises a circular groove whose diameter is about 14 mm and the diameter of the convergent port is about 5 mm. In one aspect, the straight-line distance between the convergence ports 112 of the inlet and outlet groove is about 1, 2, 3, 4, 5, 6, 7, 8, 9, or 10 mm. In one aspect, a channel 16 of about 0.1, 0.5, 1, 1.5, 2, 2.5, or 3 mm in diameter, preferably 1 mm in diameter, is designed for insertion of a detecting optical fiber which is used to collect the scatter light of the cells in the sample.

In one aspect, the inlet 11 comprises a sample pool with a circular groove structure, the top edge of which is higher than the fluid channel. In one aspect, the sample pool can store a sample of about 0.1, 0.5, 1, 1.5, 2, 2.5, or 3 mL or less in volume. In one aspect, the sample pool can store a sample of about 1 mL or less in volume. In some embodiments, the inlet 11, the first cover-layer outlet 12, and/or the second cover-layer outlet 13 are in the form of a well with gradually contracting diameters toward the bottom of the well. Preferably, the bottom of the inlet and outlets can be gradually lowered or narrowed down in the vertical direction, which helps to reduce sample retention and avoid bubbles.

In one aspect, on the lower surface of the substrate layer 2, the main fluidic channel (e.g., the detection region 25) is rectangular in shape. In one aspect, main fluidic channel 25 has a height of about 0.05, 0.1, 0.15, 0.2, 0.25, 0.3, 0.35, or 0.4 mm, and/or a width of about 0.01, 0.05, 0.1, 0.15, 0.2, 0.25, 0.3, or 0.35 mm, and/or a length of about 0.5, 1, 1.5, 2, 2.5, 3, 3.5, 4, 4.5, or 5 cm. In one aspect, the detection region 25 has a height of about 0.14 mm, and/or a width of about 0.1 mm, and/or a length of about 3 cm.

In one aspect, the ultrasonic driving frequency is about 1, 2, 3, 4, 5, 6, 7, 8, 9, or 10 MHz. In one aspect, the ultrasonic driving frequency is about 5 MHz.

In one aspect, the substrate layer 2 and the cover layer 1 can be bonded and sealed. In another aspect, the electrodes are inserted into electrode through-holes 15. By controlling the electrode voltage to electrolyze the liquid and form bubbles, cells could be deflected into the outlet of sorted samples 22.

In one aspect, groove 26 is provided in the substrate layer 2, in the vertical direction to the main fluidic channel After the cover layer and the substrate layer are bonded, groove 26 is bonded with channel 16 in cover layer 1 to form a cavity or channel, for insertion of an optical fiber for collecting the side scatter light signal. In one aspect, driving port of sorting structure or apparatus 24 is located about 0.05, 0.1, 0.15, 0.2, 0.25, 0.3, 0.35, or 0.4 mm downstream of the detection region 36. In one aspect, driving port of sorting structure or apparatus 24 is located about 0.2 mm downstream of the detection region 36, and comprises a Y-shaped bifurcated pipeline which sets connection to sorted sample outlet 22 and unsorted sample outlet 23. In one aspect, the driving port is of a flared design which gradually expands to the sorting groove 24 which has an elliptic sorting chamber.

In one aspect, the cover layer is thicker than the substrate layer and comprises inlet 11, first cover-layer outlet 12, second cover-layer outlet 13, rinsing outlet 14, fiber insertion port 16, and electrode through-hole(s) 15. In one aspect, the sizes of substrate layer 2 and cover layer 1 are matched such that they can be assembled and sealed together, for example, the two layers can be glued together. In one aspect, during the manufacturing process, inlet 11, first cover-layer outlet 12, second cover-layer outlet 13, rinsing outlet 14, and/or electrode through-hole(s) 15 can be sealed, for example by thin film, to ensure a sterile environment, and the sealed film can be punctured (e.g., with pipette tips) in a clean operating environment such as in a hood or a cell manipulation platform.

In one aspect, the fluidic channel is coated with a hydrophilic layer, thereby generating a siphon action in the gradual entrance of the pipeline to facilitate the initial sample injection and to reduce injection volume retention (such as avoiding dead volume formation). In order to maintain a constant flow of the sample after injection, the fluidic chip loaded with a sample is fixed (e.g., on a mounting holder) and then a positive pressure is applied at the inlet 11.

In one aspect, during the detection using the fluidic chip, ultrasound field of a specific wavelength (at about 5 MHz) is applied to the fluidic channel (e.g., upstream the detection region 36) by the control system. This way, the cells moving in the channel are focused into a standing wave node 41 in the vertical direction, e.g., the center plane of the horizontal dimension inside the channel. In one aspect, the ultrasonic radiation generates forces that limit the movement of cells in the vertical dimension, meaning that substantially all of the cells are flowing on the same horizontal plane.

In one aspect, to ensure that cells at different locations within the microfluidic channel are irradiated with laser of the same intensity, the fluidic channel (e.g., at detection region 36) is irradiated with a shaped laser of uniform intensity, for example, the illumination intensity of the laser spot is distributed in a rectangular shape. In one aspect, the detection region of main fluidic channel 25 is where a flat-top beam is applied. In a particular aspect, the light detection region 36 is where the flat-top beam is applied. In one aspect, the flat-top beam is applied to a rectangular area, for example, an area on the horizontal plane (e.g., substantially all of the cells are flowing on the same horizontal plane). In one aspect, the flat-top laser beam is generated by a binary optical element and is characterized in the rectangular distribution of light intensity, and not the traditional oval-shaped Gaussian distribution. This way, although the cells may be moving along different paths on the same horizontal place, their different locations will not cause the cells to be stimulated with light of different intensity. In one aspect, the measured scatter light and fluorescent light of the cells at different sampling position in the horizontal dimension will not be affected by the non-uniform intensity of the excitation light.

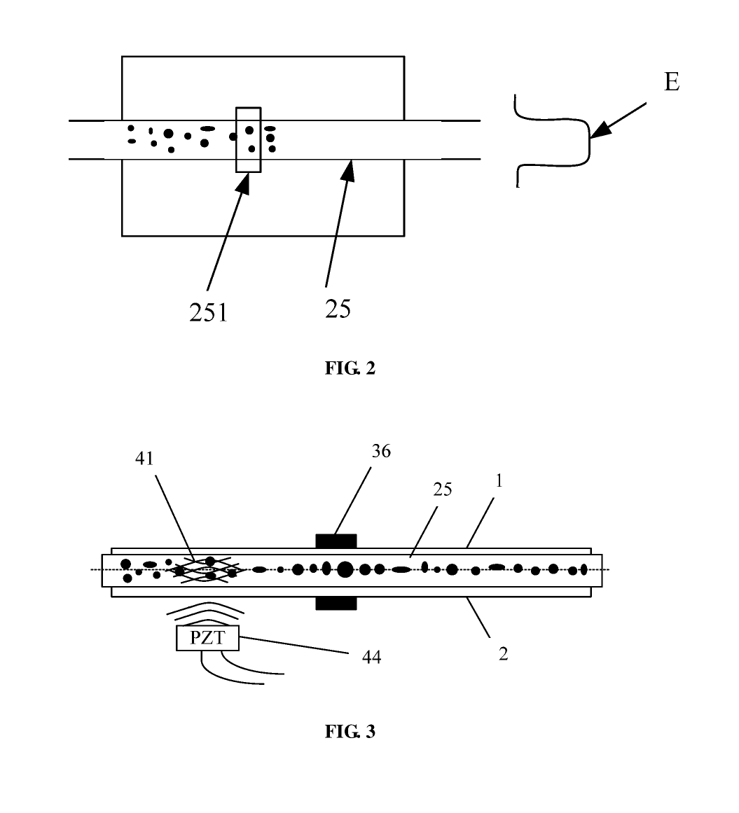

Referring to FIG. 2, which is a schematic diagram of the principle of flat-top beam spot irradiation according to one aspect of the present disclosure, the presently disclosed fluidic cell and method ensure that cells at different positions in the horizontal direction are excited by the same intensity of light. In one aspect, the traditional round or oval laser spot can be replaced by or transformed into a rectangular flat-top spot 251. In one aspect, the area of illumination by the rectangular flat-top spot 251 is the light detection region 36 within the main fluidic channel 25, and is downstream of the ultrasonic focusing region in the direction of sample flow. In one aspect, the laser is produced by a binary optical lens, e.g., by transforming a traditional laser such as one in Gaussian distribution. In one aspect, the cells irradiated by the flat-top spot in fluidic channel 25 are included within the optical detection zone 36. FIG. 2 is a top view of the main fluidic channel 25 and detection region 36 within the channel, and shows that the light intensity E of the detection area 251 is uniform, thus avoiding differences in excitation light intensity caused by the elliptical Gaussian intensity distribution of the light spot. In one aspect, the present disclosure provides ultrasound focusing of cells in the vertical direction, in combination with a flat-top laser beam irradiating the cells on the same horizontal plane. This way, in one aspect, the technical results of the traditional flow cytometry can be achieved without resorting to the traditional hydrodynamic focusing by sheath flow in conjunction with a Gaussian distributed point spot, and present technical solution ensures the accuracy of test results. In another aspect, the present disclosure permits a direct sample injection into the fluidic channel, avoiding the use of sheath flow and the dilution of sorted cells associated with traditional flow cytometry.

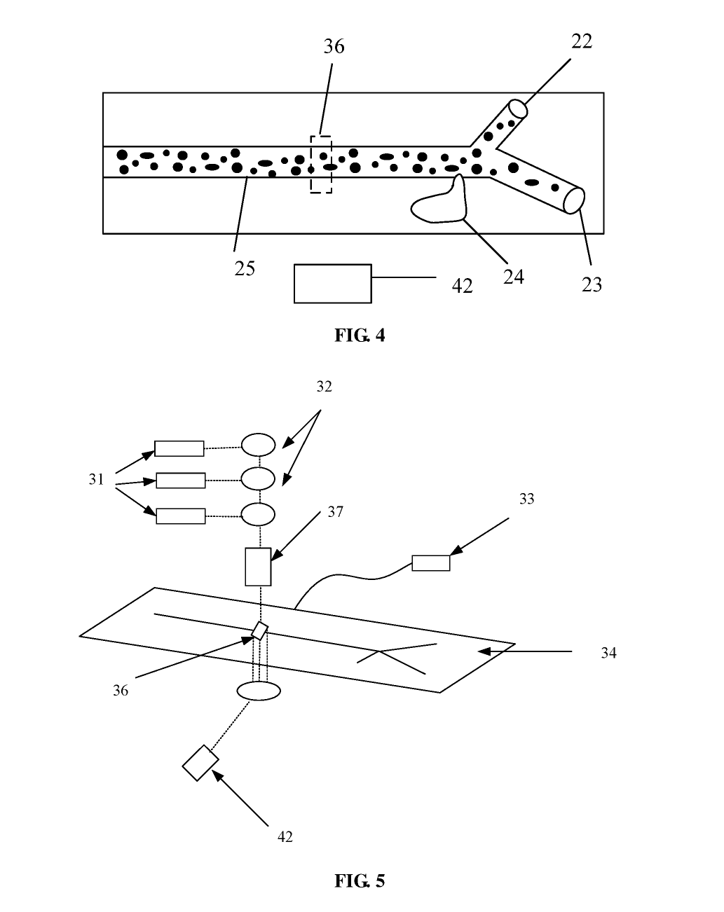

FIG. 3 is a sectional view of the fluidic chip shown in FIG. 1, and FIG. 4 is an elevated view of the fluidic chip shown in FIG. 1 from above. In one aspect, after the substrate layer and the cover layer are bonded and sealed, the sample in the fluidic channel is analyzed. In one aspect, the sample is focused onto a horizontal plane in the direction of sample flow after reaching the ultrasonic coverage area of ultrasound device (such as a transducer) 44. In one embodiment, transducer 44 comprises a piezoelectric ceramic such as lead zirconate titanate (PZT), and is provided below the substrate layer 2. In one aspect, the ultrasound device transmits ultrasound waves in the driving region which is a part of the detection region in the fluidic channel 25. In one embodiment, after the standing wave 41 in the driving region is formed, cells and particles in the sample are focused within the fluidic channel onto a horizontal plane, as shown by the dashed line of FIG. 3. In one aspect, the optical system for laser spot shaping (e.g., device 42 in FIG. 4) is provided below the substrate layer 2. In one aspect, the optical system emits excitation light from bottom to top with a flat-top spot to form an optical detection zone 36 and illuminates the optical detection zone, which in one embodiment is downstream of the driving region where standing waves 41 are formed. After sorted by the sorting groove 24, the sample can be recycled after flowing through the outlet of sorted samples 22 or the outlet of unsorted samples 23.

The traditional flow cell sorting system uses the technology of cell electrostatic deflection, which has a design that is open to the air or air circulation. In addition, the droplets generated by the high frequency oscillation will result in aerosol contamination, leading to biological hazard. In some embodiments of the present disclosure, the fluidic chip is sealed and provides a more secure assay system and does not produce hazardous aerosols.

Sample consumption in actual assays (such as clinical testing) should be as little as possible, such as less than 50 μL, especially for rare, precious samples such as circulating tumor cells in human peripheral blood, forensic samples, and other samples which need be separated and cannot be replaced. However, in existing flow cytometry assays, sheath fluid is introduced into the fluidic chamber or chips to hydrodynamically constrain the sample solution. The sheath fluid adds a lot of extra volume and dilutes the actual test sample, rendering it difficult to recycle sample after analysis. In addition, the small number of sorted cells on the chip will be further diluted by the extra sheath flow, leading to difficulties in finding and analyzing the sorted cells. In one aspect, the fluidic channel in the present disclosure has compact sizes and a sheath-free design, which can improve the utilization and recovery rate of the sample after sorting, and can achieve the test of a small amount of sample through the inverted cone-shaped inlet and outlets (such as inlet 11 and outlets 12 and 13).

In some aspects, the structure of the fluidic chip in the present disclosure is simple; the cost for manufacture and operation is low; it achieves focusing of the cells (or other analytes in the sample) and accurate detection when a small amount of sample is injected; and it is easy to automate the process and integrate with other technologies, such as technologies using bubble micro pump. In one aspect, the fluidic chip disclosed herein has a compact, multi-channel, and parallel design that can improve the throughput of cell detection and separation.

In some embodiments, also provided herein is a flow cytometer system with reference to FIG. 5, which is a structural diagram showing the structure of a flow cytometer sorting system according to one aspect of the present disclosure. The flow cytometer system in FIG. 5 comprises: fluidic chip 34 according to any of the preceding embodiments; an ultrasound device provided in the ultrasonic driving zone (not shown in FIG. 5), which is used to focus analytes in a sample with ultrasound waves in order to analyze the sample in the fluidic chip; a device for shaped laser disposed in the light detecting region 36, which is used to irradiate the sample by a flat-top laser spot or laser beam when testing the sample in the fluidic chip; an electronic processing system for data collection and analysis and for the logic control of sorting pulses.

In one aspect, the microscale channel of fluidic chip 34 is substantially Y-shaped or of a cruciform structure. In one aspect, the sample is added into the fluidic channel continuously with the effect of initial capillary force and positive pressure applied at the entrance, and then the cells are randomly arranged in the main fluidic channel 25, including in the detection region 36, before the cells are focused. An ultrasound device such as a transducer comprising a piezoelectric ceramic such as lead zirconate titanate (PZT) can be attached to the lower surface of the chip 34 by an ultrasound gel or glue. In one aspect, the ultrasound device emits a periodic sound wave which penetrates the sample solution in the fluidic channel and is reflected at the interface of the cover layer surface and the air, thus forming a standing wave with the superposition of incident waves in the middle of the channel. The cells are forced to move toward and accumulate on a horizontal plane (such as the middle place) inside the channel, where the potential energy of cells is lowest at the acoustic pressure node of the standing wave. It should be noted that, although FIG. 5 does not show the ultrasound device such as a transducer, the specific implementation of the ultrasound device can be found in the above described embodiments and are therefore not be repeated here.

In one aspect, downstream of the acoustic transducer driving zone is the optical detection zone 36 as shown in FIG. 5. A laser device 42, such as a semiconductor laser device, is provided below fluidic chip 34 in order to emit a flat-top laser spot to irradiate the sample in the light detection region 36. In one aspect, the excitation light is shaped into a rectangular flat-top spot by binary optical lens, and irradiates the optical detection zone 36 from bottom to top, and then irradiates the cells in the sample in order to produce scatter light and excited fluorescence signals that can be captured and analyzed in order to determine one or more properties of each cell in a cell population. Physical and chemical properties of cells are revealed on these optical signals, which are collected by the lens 37, separated by a dichroic mirrors system 32 to different PMT (photomultiplier tube) detection channels 31, and finally converted into and displayed as a digital signal in the electronic processing system. The electronic processing system (not shown in FIG. 5) with each of the photomultiplier tube 31 is connected to obtain the multi-parameter data. Scatter light detecting photomultiplier tube 33 collects the signals of scatter light through the detecting optical fiber, which is inserted into the lateral channel (for example, the channel formed by groove 26 in the substrate layer and fiber insertion port 16 in the cover layer) and connected to the electronic processing system.

Intensity of scatter light and specific fluorescence light varies in different cells. Data for these parameters of the cells are collected and processed when cells flow through the detection zone, and the electronic processing system will generate appropriate bubble driving pulses based on these parameters to separate the cells into different channel outlets. In some embodiments, the separating or sorting function can also be accomplished by a high-speed switching solenoid valve and/or a piezoelectric ceramic valve by rapidly changing the flow resistance characteristics in order to deflect the cells in a particular fluidic direction in the channel to achieve the specified cell separation. Sorted cells can be recovered into a collection outlet or a collection tube.

It should be noted, the connection between and the structures of fluidic chips 34, ultrasound device 44 and shaped laser device 42 of the flow cytometer sorting system are described in the above embodiments and are not repeated here.

In some embodiments, the fluidic channel of the fluidic chip is of a rectangular cross-section, and the ultrasonic resonance frequency of the fluid channel is about 0.5, 1, 1.5, 2, 2.5, or 3 MHz. In some embodiments, the fluidic channel of the fluidic chip is of a rectangular cross-section, and the ultrasonic resonance frequency of the fluid channel is about 1.47 MHz. In other embodiments, the fluidic channel of the fluidic chip is of a circular cross-section, and the ultrasonic resonance frequency of the fluidic channel is about 500, 600, 700, 800, 900, or 1000 kHz. In other embodiments, the fluidic channel of the fluidic chip is of a circular cross-section, and the ultrasonic resonance frequency of the fluidic channel is about 700 kHz.

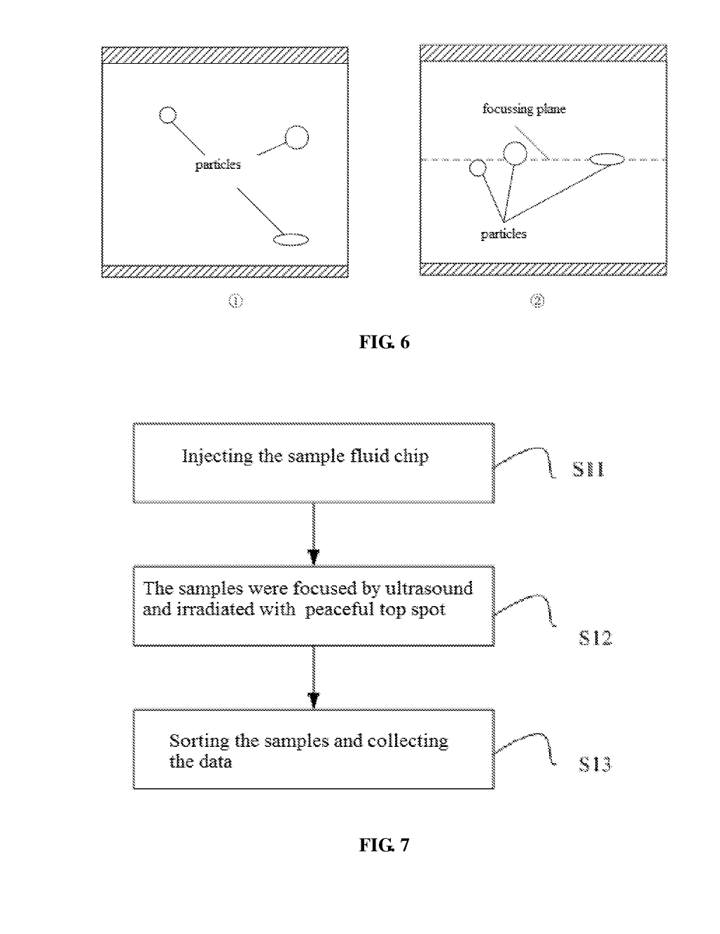

Referring to FIG. 6, which is a schematic diagram showing the results of ultrasonic focusing of cells. Experiments have shown that when the transducer is turned off, as shown in the left panel of FIG. 6, the cells or particles in the fluidic channel are randomly distributed in the vertical dimension. When the transducer is turn on, as shown in the right panel of FIG. 6, the cells or particles in the fluidic channel are driven to gather in the middle plane of the fluidic channel (shown in dotted lines of the focal plane in the horizontal direction). Thus, ultrasonic driving can achieve effective cell focusing. FIG. 6 is a partial side view of the fluidic channel.

In some embodiments, experiments have shown that the cells or particles in the sample exist in two different states, when the average flow velocity of the sample is about 8.2 mm/s and about 32.8 mm/s, respectively. In one aspect, it can be observed from the side view of the fluidic channel that the cells or particles are mostly aligned in a line (the aforementioned horizontal plane appears a straight line in the side view) when the average velocity is about 8.2 mm/s. In another aspect, the particles are gathered in the middle segment but not exactly aligned in a line at a flow velocity of about 32.8 mm/s. Hence, in general, because it takes time for the ultrasound device to establish a sound field, the degree of cell focusing is higher at a slower flow rate (so it allows the standing wave more time to act on the cells), and shorter focusing distance is required (for example, a shorter segment of the fluidic channel is needed to be the ultrasonic driving zone). Thus, in one aspect, the flow rate can be adjusted according to the cell or particle size in order to achieve optimal focusing. In some aspects, the flow rate is between about 1 mm/s and about 50 mm/s, for example, about 1, 2, 3, 4, 5, 6, 7, 8, 9, 10, 11, 12, 13, 14, 15, 16, 17, 18, 19, or 20 mm/s.

In some embodiments, experiments have shown that particles exist in two states when the sizes of the cells or particles are about 20 μm and about 10 μm, respectively. In one aspect, under the same flow velocity and the same working voltage of the transducer, the cells or particles are almost aligned in a line (in a side view) with a better focusing effect when the size is about 20 μm. In another aspect, the cells or particles gather in the middle plane but are not exactly aligned in a line (in a side view) with when the size is about 10 μm. In one aspect, a larger diameter of the cells or particles leads to a smaller viscous acceleration and a better focusing effect. In addition, the cells and particles with larger diameters are easier to agglomerate too. Therefore, in one aspect, the flow velocity should be determined according to the sizes of the cells or particles during ultrasound focusing. In some aspects, the average diameter of the analyte is between about 1 μm and about 1 mm, for example, about 1, 2, 3, 4, 5, 6, 7, 8, 9, 10, 11, 12, 13, 14, 15, 16, 17, 18, 19, or 20 μm.

In one aspect, the cells or particles are mostly aligned in a line (in a side view) with a better focusing effect when the driving voltage is about 16V. In another aspect, the cells or particles gather on the middle plane but not all of them are exactly aligned in a line (in a side view) with a less optimal focusing effect when the driving voltage is about 6.4V. This is due, in one aspect, to the proportional relation between the force of ultrasound field and the power of the driving signal. A higher amplitude of the driving signal results in a faster rate of cell focusing. In some aspects, the driving voltage is between about 1 V and about 50 V, for example, about 1, 2, 3, 4, 5, 6, 7, 8, 9, 10, 11, 12, 13, 14, 15, 16, 17, 18, 19, or 20 V.

In one aspect, flow cytometer data analyzing and sorting of the cells or particles can be achieved by the ultrasonic focusing and flat-top spot illumination in the flow cytometer sorting system disclosed herein. The test results prove to be accurate, and the detection sensitivity can be improved in comparison to conventional flow cytometry.

In one aspect, the fluidic chip can be a plastic chip or glass chip made through the mature technology of one-step modeling. Since the cost of manufacturing the fluidic chip is low, the chip can be disposable after use, and this greatly reduces or even avoids cross-contamination due to reuse of the chip. The chip also has a sterile, sealed system which can effectively prevent biological contamination. In addition, the ultrasound device (such as a focusing actuator of piezoelectric ceramic) and/or the laser device can be placed outside the sterile, sealed system of the fluidic chip, for example, by externally mounting the device(s) to the lower surface of chip. In one aspect, only a small piece of the piezoelectric ceramic is required to be placed beneath the driving zone. At the same time, in one aspect, the device disclosed herein does not need sheath fluid, which further reduces costs and also avoids dilution of the sample, the recovered sample, and the sorted cells.

In one aspect, the system disclosed herein uses a flat-top laser spot technology to ensure the cells at different positions in the horizontal direction are stimulated by the same intensity of laser irradiation, improving the accuracy of detection. The cells sorting can also be completed by integrating the bubble driver designed on the chip.

In still another aspect, disclosed herein is a method of cell sorting, for example, as shown in FIG. 7, which is a schematic flow of a focusing detection method based on a cell sorting system according to one aspect of the present disclosure.

In some embodiments, the method for flow cytometer sorting comprises: Step S11—injecting the sample into a fluidic chip; Step S12—focusing the sample with ultrasonic waves and irradiating the cells or particles in the sample with a laser of flat-top spot; and Step S13—collecting the multi-parameter data of the sample and separating the target cells.

In one aspect, the flow cytometer sorting method comprises irradiating the cells with a flat-top beam, after ultrasonic focusing of the cells which makes the cells flow on the same horizontal plane, so that a uniform intensity of laser irradiation of the cells is received within the horizontal plane, in order to ensure the test accuracy.

The above description of the disclosed embodiments enables those skilled in the art to make or use the claimed subject matter. It is obvious that a variety of modifications to these embodiments could be made by those skilled in the art, and the general principles defined herein may be realized in other embodiments without departing from the spirit or scope of the present invention. Accordingly, the present disclosure will not limit the scope of these embodiments herein, but rather should be viewed consistent with the principles disclosed herein and the novel features of the claimed subject matter.

The following embodiments are provided to further illustrate the present disclosure.

### Embodiment 1

A microfluidic chip used in a flow cytometry sorting system, which is characterized that the microfluidic chip comprising: a cover layer and a substrate layer, which are designed to face each other; a fluidic channel provided inside the fluidic chip, which comprises one or more inlets at a first end of the fluidic channel, one or more outlets at a second end of the fluidic channel, and a detection area between the inlet(s) and outlet(s); a sorting structure or apparatus locating at the junction of the detection area and the outlet(s); an ultrasonic driving area provided on the lower surface of the substrate layer; an ultrasound actuator attached below the surface of the detection zone for ultrasonic focusing of the sample within the fluidic channel; a light detection region provided through the lower surface of the substrate layer, wherein the light detection region is illuminated by a laser device providing a shaped laser beam, and the sample in the detection zone is irradiated with the shaped laser beam such as a flat-top laser spot, wherein the one or more outlets comprise an outlet of sorted samples and an outlet of unsorted samples, and when the sample flowing in the fluidic chip is detected and/or analyzed, the sorting structure or apparatus is used to deflect the sample flow and separate the sorted sample into a fluidic channel of sorted samples connected to the outlet for sorted samples.

### Embodiment 2

The fluidic chip of Embodiment 1, wherein the cover layer and substrate layer are separable and can be sealed together, and the fluid channel comprises a groove in the upper surface of the substrate layer which is faces the cover layer.

### Embodiment 3

The fluidic chip of Embodiment 2, wherein the cover layer comprises: a cover layer inlet, which is connected to the inlet of the fluidic channel, for example, through a fluidic channel; a first cover-layer outlet, connected to the outlet of sorted sample; and a second cover-layer outlet, connected to the outlet of unsorted sample.

### Embodiment 4

The fluidic chip of Embodiment 2 or 3, wherein the cover layer comprises: a lateral rinsing outlet, for example for getting rid of gas trapped in the fluidic channel, which rinsing outlet is connected to the main fluidic channel.

### Embodiment 5

The fluidic chip of Embodiment 2, wherein the sorting structure or apparatus comprises a sorting groove which is provided on the upper surface (facing to the cover chip) of the substrate layer, wherein electrode through-holes are provided in the cover layer at positions corresponding to the sorting groove.

### Embodiment 6

The fluidic chip of Embodiment 5, wherein the fluidic channel comprises: a sorted sample channel which is provided between the detection zone and the sorted sample outlet, and an unsorted sample channel which is provided between the detection zone and the unsorted sample outlet, wherein the width of the unsorted sample channel is wider than the width of the sorted sample channel, and they have the same extending direction.

### Embodiment 7

The fluidic chip of Embodiment 5, wherein the upper cover layer and/or the substrate layer comprises or comprise glass and/or plastic.

### Embodiment 8

The fluidic chip of Embodiment 7, wherein the cover layer and/or the substrate layer comprises or comprise glass, the ratio of the thickness of the substrate layer located below the fluid channel, the height of the fluidic channel, and the thickness of the cover layer located above the fluid channel is about 2:1:2.

### Embodiment 9

The fluidic chip of Embodiment 7, wherein the cross section of the fluidic channel in the extending direction of the fluidic chip is rectangular.

### Embodiment 10

A flow cytometry sorting system, comprising: a fluidic chip according to any one of Embodiments 1-9; an ultrasound actuator provided in the ultrasonic driving zone that is used to force the cells in the channel into single-cell flow through a focused ultrasound; a laser illumination provided in the light detection zone, which is used to detect cells in a sample in the detection zone by a flat-top spot irradiation, when flow cytometry analysis is carried out in the fluidic chip; and an electronic processing and/or analyzing system used for data collection and/or analysis, and/or generation of a sorting pulse.

### Embodiment 11

A method for using a flow cytometry sorting system comprising, for example, a fluidic chip according to any one of Embodiments 1-9, the method comprising: injecting a sample into the integrated fluidic chip; focusing cells or other analytes in the sample onto the same plane with a force such as an ultrasonic force, and exciting the cells or other analytes with a flat-top spot laser; collecting the data of the cells or other analytes in the sample and sorting the interested cells or other analytes.

1. A fluidic chip for analyzing a sample, comprising:
a fluidic channel comprising an inlet for adding a sample, and an outlet;
a driving region and an optical detection region which are arranged sequentially in the direction of sample flow from the inlet to the outlet, wherein:
the driving region is an ultrasound driving region configured to provide an ultrasound to focus analytes in the sample onto substantially the same plane as the analytes flow through the fluidic channel in the ultrasound driving region, and the optical detection region is configured to provide a light to irradiate the analytes as they flow through the fluidic channel in the optical detection region after being focused onto substantially the same plane, such that the analytes on the same plane receive substantially the same intensity of light irradiation; or
the driving region is configured to provide a force to focus analytes in the sample onto substantially the same plane as the analytes flow through the fluidic channel in the driving region, and the optical detection region is configured to provide a flat-top light beam to irradiate the analytes as they flow through the fluidic channel in the optical detection region after being focused onto substantially the same plane, such that the analytes on the same plane receive substantially the same intensity of light irradiation; or
the driving region is an ultrasound driving region configured to provide an ultrasound to focus analytes in the sample onto substantially the same plane as the analytes flow through the fluidic channel in the ultrasound driving region, and the optical detection region is configured to provide a flat-top light beam to irradiate the analytes as they flow through the fluidic channel in the optical detection region after being focused onto substantially the same plane, such that the analytes on the same plane receive substantially the same intensity of light irradiation.

2. The fluidic chip of claim 1, wherein the fluidic chip comprises a cover layer and a substrate layer which are capable of engaging each other.

3. The fluidic chip of claim 2, wherein the cover layer and the substrate layer are bonded and sealed to provide the fluidic channel.

4. The fluidic chip of claim 3, wherein the fluidic channel comprises one inlet and at least two outlets, wherein the one inlet is provide at a first end of the fluidic channel and the at least two outlets are provided at a second end of the fluidic channel, and the at least two outlets comprise an outlet for analytes of interest and another outlet for analytes not of interest.

5. The fluidic chip of claim 1, further comprising a sorting structure between the optical detection region and the outlet.

6. The fluidic chip of claim 1, wherein the ultrasound driving region comprises an ultrasound device for providing the ultrasound.

7. The fluidic chip of claim 6, wherein the ultrasound device comprises a piezoelectric ceramic.

8. The fluidic chip of claim 2, wherein the ultrasound driving region comprises a lead zirconate titanate (PZT) slice attached to the lower surface of the substrate layer and positioned below the fluidic channel in the ultrasound driving region.

9. The fluidic chip of claim 1, wherein the optical detection region comprises a light source for providing the flat-top light beam.

10. The fluidic chip of claim 4, wherein the cover layer comprises:
a sample inlet configured to be in fluidic communication with the inlet of the fluidic channel when the cover layer and the substrate layer are engaged;
a first cover-layer outlet configured to be in fluidic communication with the outlet for analytes of interest when the cover layer and the substrate layer are engaged; and
a second cover-layer outlet configured to be in fluidic communication with the outlet for analytes not of interest when the cover layer and the substrate layer are engaged.

11. The fluidic chip of claim 10, wherein the cover layer further comprises a rinsing outlet capable of being in fluidic communication with the fluidic channel.

12. The fluidic chip of claim 10, wherein the fluidic chip further comprises a sorting structure between the optical detection region and the outlet, the sorting structure comprises a sorting groove provided on the substrate layer, and the cover layer further comprises a through-hole for inserting one or more electrodes in the sorting groove.

13. The fluidic chip of claim 12, wherein bubbles are generated in the sorting structure to direct analytes of interest through the fluidic channel and toward the outlet for analytes of interest.

14. The fluidic chip of claim 4, further comprising a first segment of the fluidic channel for analytes of interest between the optical detection region and the outlet for analytes of interest, and a second segment of the fluidic channel for analytes not of interest between the optical detection region and the outlet for analytes not of interest, wherein the average diameter of the fluidic channel for analytes not of interest is greater than the average diameter of the fluidic channel for analytes of interest.

15. The fluidic chip of claim 14, wherein the fluidic chip further comprises a sorting structure between the optical detection region and the first and second segments of the fluidic channel.

16. The fluidic chip of claim 3, wherein the cover layer and/or the substrate layer comprises or comprise glass and/or plastic.

17. The fluidic chip of claim 16, wherein both of the cover layer and the substrate layer are made of glass, and when the cover layer and the substrate layer are bonded and sealed, the ratio of the glass thickness below the fluidic channel, the height of the fluidic channel, and the glass thickness above the fluidic channel is about 2:1:2.

18. The fluidic chip of claim 1, wherein the cross-section of the fluidic channel in the direction of sample flow is square or rectangular in shape.

19. A flow cytometry system, comprising the fluidic chip of claim 1, an ultrasound device for providing the ultrasound, a light source for providing the flat-top light beam, and an electronic system for data collection and analysis.

20. A method for analyzing a sample, comprising:
loading a sample in the inlet of the fluidic chip of claim 1;
focusing analytes in the sample onto substantially the same plane as the analytes flow through the fluidic channel, optionally using an ultrasound;
irradiating analytes as they flow through the fluidic channel with a light beam, optionally a flat-top light beam, after the analytes are focused onto substantially the same plane, such that analytes on the same plane receive substantially the same intensity of light irradiation; and
collecting scatter light and/or fluorescent light signals from the analytes and comparing the light signals with a predetermined value; and
sorting the analytes into outlets for analytes of interest and analytes not of interest based on the comparison.

21. The method of claim 20, wherein the analytes comprise a cell, an organelle, a cell fragment, a multicellular organism, and/or a multicellular complex.
